(19) United States
(12) Patent Application Publication
(10) Pub. No.: US 2015/0029750 A1
(43) Pub. Date: Jan. 29, 2015

(54) LIGHT GUIDE PLATE AND BACKLIGHT MODULE INCORPORATING THE SAME

(71) Applicant: HON HAI PRECISION INDUSTRY CO., LTD., New Taipei (TW)

(72) Inventor: Li-Ying WANG HE, Tu-Cheng (TW)

(73) Assignee: HON HAI PRECISION INDUSTRY CO., LTD., New Taipei (TW)

(21) Appl. No.: 14/067,963

(22) Filed: Oct. 31, 2013

(30) Foreign Application Priority Data
Jul. 24, 2013 (TW) 102126536

(51) Int. Cl. F21V 8/00; F21K 99/00

(52) U.S. Cl. CPC G02B 6/003; F21K 9/52
USPC 362/608; 385/33

(57) ABSTRACT

A light guide plate includes a light incident face, a bottom face adjacent to the light incident face and a light exit face opposite to the bottom face. The micro lenses are formed on the light incident face in series to diffuse light incident thereon. Two adjacent micro lenses cooperatively define a V-shaped groove therebetween. Each groove defines an opening. The width of the openings of the grooves gradually changes from a center of the light incident face toward lateral sides thereof. A backlight module incorporating the light guide plate is also provided.

### TECHNICAL FIELD

The present disclosure relates generally to a light guide plate and a backlight module incorporating the light guide plate, wherein the backlight module has an improved light distribution and utilization efficiency.

### DESCRIPTION OF RELATED ART

LEDs are solid state light emitting devices formed of semiconductors, which are more stable and reliable than other conventional light sources such as incandescent bulbs. Thus, LEDs are being widely used in various fields such as numeral/character displaying elements, signal lights, light sources for lighting and display devices.

Nowadays, LED light sources are widely applied for illumination, such as being used in an edge type backlight module assembly for illuminating a planar display such as a liquid crystal display (LCD). The LED light sources are usually positioned at one side of a light guide plate. The light guide plate includes a light incident face facing the LED light sources, a bottom face adjacent to the light incident face, and a light exit face adjacent to the light incident face and opposite to the bottom face thereof

However, as the light incident face is a flat surface, light rays emitted from the LED light sources are refracted at a small angle of refraction into the light guide plate through the light incident face, thereby leaving two dark strip-shaped areas inside the light guide plate along two side edges thereof un-illuminated. Therefore, such a light guide plate and a backlight module incorporating the light guide plate are difficult to satisfy the requirements of uniform light distribution. Furthermore, some light emitted from the LED light sources is reflected by the light incident face to an outside of the light guide plate, which causes the light utilization of the LED light sources to be low.

What is needed therefore is a light guide plate and a backlight module incorporating the light guide plate which can overcome the above mentioned limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is an isometric, perspective view of a backlight module in accordance with a first embodiment of the present disclosure.

FIG. 2 is a top plan view of the backlight module of FIG. 1.

FIG. 3 is an enlarged schematic view of a pair of micro lenses of a light guide plate of the backlight module of FIG. 1.

FIG. 4 is a schematic view of a backlight module in accordance with a second embodiment of the present disclosure.

FIG. 5 is a schematic view of a backlight module in accordance with a third embodiment of the present disclosure.

### DETAILED DESCRIPTION

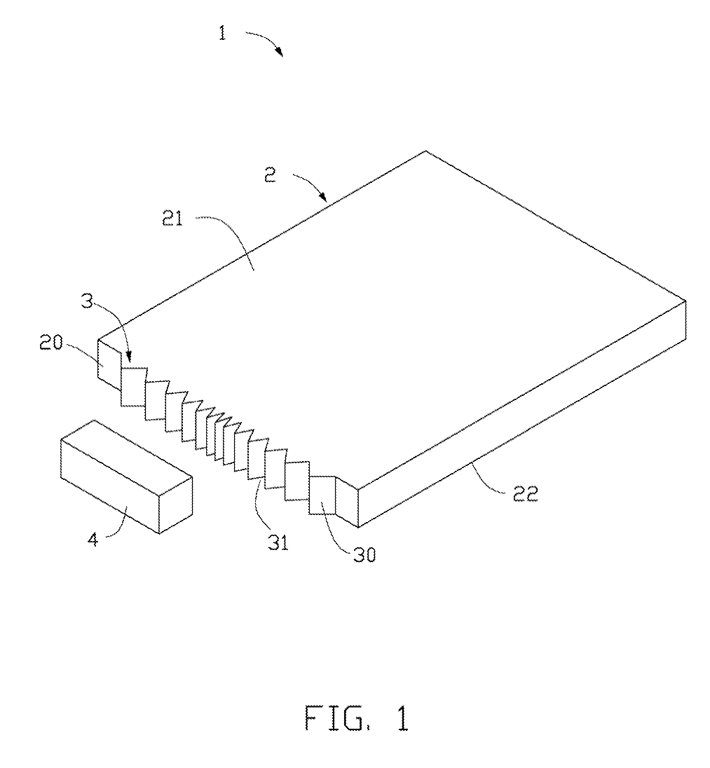

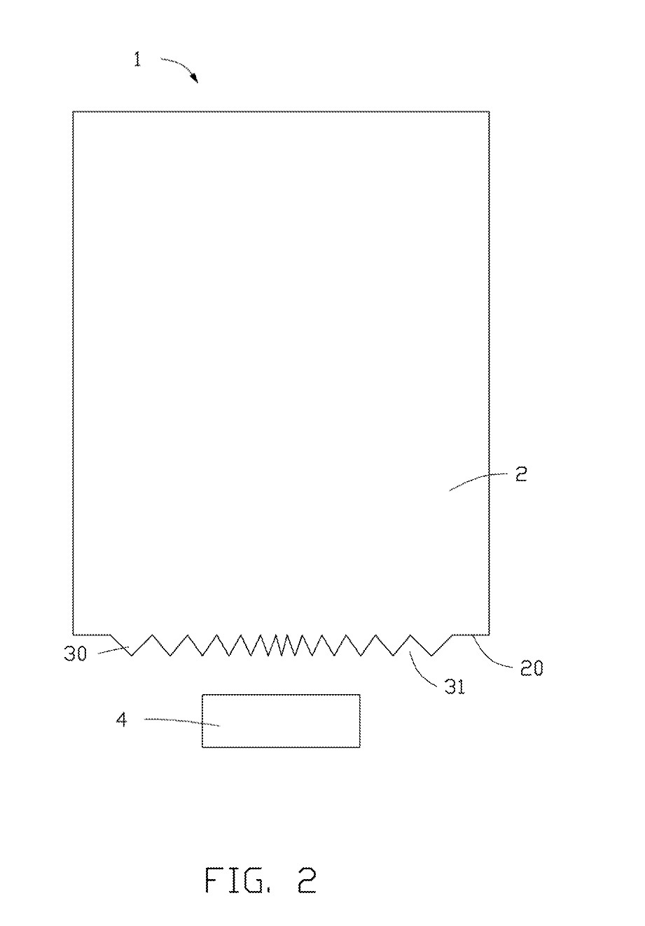

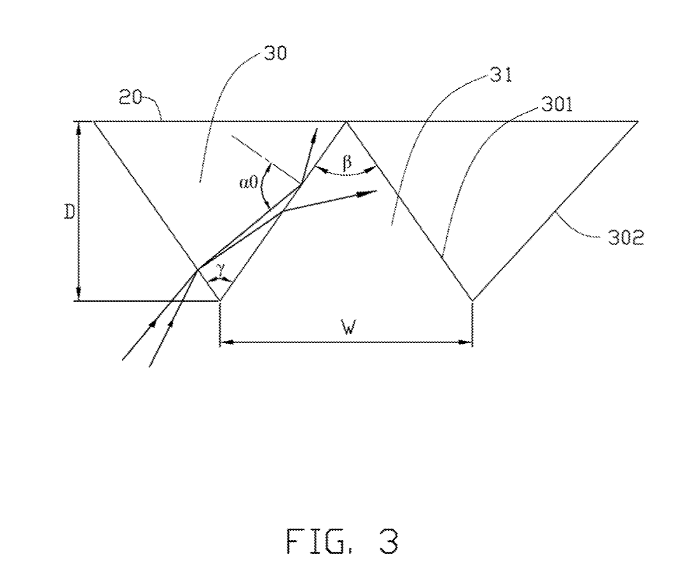

Referring to FIGS. 1, 2 and 3, a backlight module 1 in accordance with a first embodiment of the present disclosure includes an LED light source 4 and a light guide plate 2 coupled to the LED light source 4. The light guide plate 2 includes a light incident face 20, a bottom face 22 adjacent to the light incident face 20 and a light exit face 21 adjacent to the light incident face 20 and opposite to the bottom face 22. The LED light source 4 faces the light incident face 20 of the light guide plate 2.

The light guide plate 2 is rectangular and the light incident face 20 is perpendicular to the light exit face 21 and the bottom face 22 thereof. A plurality of micro lenses 30 are formed on the light incident face 20 of the light guide plate 2 in series to diffuse light incident thereon. The micro lenses 30 are arranged in a line 3 along the light incident face 20. Each micro lens 30 is an elongated prism extending lengthwise from the light exit face 21 to the bottom face 22 of the light guide plate 2.

Each micro lens 30 is a triangular prism and has a triangular cross section. In details, each micro lens 30 has an isosceles triangular cross section. Two adjacent micro lenses 30 cooperatively define a V-shaped groove 31 therebetween. In more details, the micro lens 30 includes two opposite inclined side surfaces 301, 302 relative to the light incident face 20 of the light guide plate 2. An inclined side surface 302 of the micro lens 30 intersects another inclined side surface 301 of adjacent micro lens 30 to define the groove 31.

In the first embodiment, a width W of the opening of each groove 31 increases from a center of the light incident face 20 toward lateral sides thereof. A depth D of each groove 31 is equal to each other. An angle β defined between an inclined side surface 302 of a micro lens 30 and a neighboring inclined side surface 301 of an adjacent micro lens 30 increases from the center of the light incident face 20 toward the lateral sides thereof. In addition, an apex angle γ of each micro lens 30 increases from the center of the light incident face 20 toward the lateral sides thereof

The LED light source 4 is positioned in front of the light incident face 20 of the light guide plate 2, and an optical axis of the LED light source 4 is aligned with a center of the light incident face 20 of the light guide plate 2. In other words, an optical axis of the LED light source 4 is aligned with the groove 31 located at the center of the light incident face 20 which has a minimum opening width.

The light emitted from the LED light source 4 is refracted at a large angle into the micro lens 30 through the inclined side faces 301, and a portion of the light is reflected toward the light incident face 20 of the light guide plate 2 by the opposite inclined side faces 302. In more details, the light having an angle of incidence that exceeds the critical angle α0 for total internal reflection at lens-air interface is reflected by the inclined side faces 301, 302 of the micro lens 30 toward the light incident face 20 of the light guide plate 2. The light having an angle of incidence less than the critical angle α0 for total internal reflection at lens-air interface is refracted out the micro lens 30 from the inclined side face 302 and enters into the adjacent micro lens 30 through the inclined side face 301 thereof.

That is to say, the light emitted from the LED light source 4 is diffused by the micro lenses 30 formed on the light incident face 20 of the light guide plate 2, thereby eliminating the dark strip-shaped areas existing inside the light guide plate 2 and creating a uniform light distribution inside the light guide plate 2. Furthermore, by the provision of the micro lenses 30, more light can enter the light guide plate 2 through the light incident face 20, whereby the light utilization efficiency of the LED light source 4 can be enhanced.

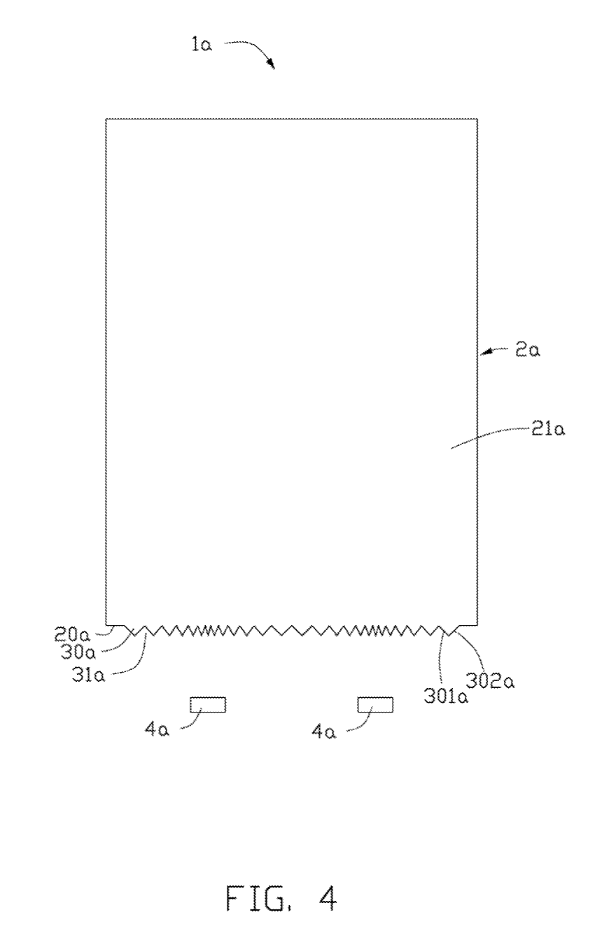

Referring to FIG. 4, different from the backlight module 1 shown in the FIG. 1, a backlight module 1a in accordance with a second embodiment includes a pair of LED light sources 4a and a light guide plate 2a coupled to the LED light sources 4a. The LED light sources 4a are symmetrically positioned in front of a light incident face 20a of the light guide plate 2a with respect to a center of the light incident face 20a.

In the second embodiment, a width of the opening of each groove 31a firstly decreases gradually and then increases gradually from the center of the light incident face 20a toward the lateral sides thereof. And an optical axis of each LED light source 4a is aligned with the groove 31a having a minimum opening width. An angle defined between an inclined side surface 302a of the micro lens 30a and a neighboring inclined side surface 301a of an adjacent micro lens 30a firstly decreases gradually and then increases gradually from the center of the light incident face 20a toward the lateral sides thereof. In addition, an apex angle of each micro lens 30a firstly decreases gradually and then increases gradually from the center of the light incident face 20a toward the lateral sides thereof.

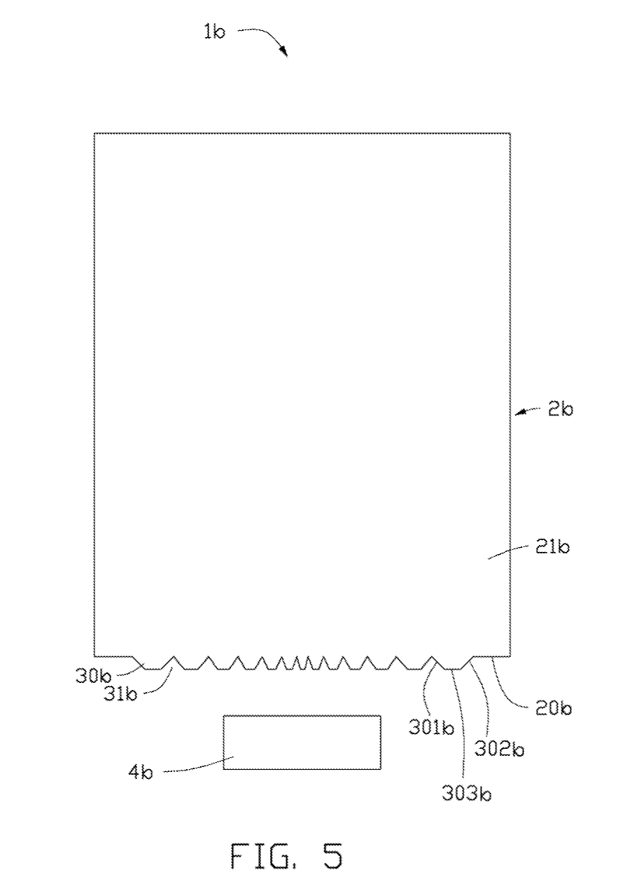

Referring to FIG. 5, different from the backlight module 1 shown in the FIG. 1, each micro lens 30b of a light guide plate 2b of a backlight module lb in accordance with a third embodiment of the present disclosure is a trapezoidal prism and has a trapezoidal cross section.

Each micro lens 30b includes two opposite inclined side faces 301b, 302b relative to the light incident face 20b of the light guide plate 2b, and a flat connecting face 303b interconnecting the opposite inclined side faces 301b, 302b. The connecting face 303b is parallel to the light incident face 20b of the light guide plate 2b.

In the present disclosure, it is to be understood that a degree of an inclination of the inclined side face 301, 302, 301a, 302a, 301b, 302b relative to the light incident face 20, 20a, 20b could be changed according to the actual requirements of light distribution inside the light guide plate 2, 2a, 2b.

It is to be appreciated that in a further alternate embodiment a bottom of an inclined side face 301, 302, 301a, 302a, 301b, 302b of each micro lens 30, 30a, 30b is spaced a distance from a bottom of a neighboring inclined side face 301, 302, 301a, 302a, 301b, 302b of an adjacent micro lens 30, 30a, 30b. That is to say, an inclined side face 301, 302, 301a, 302a, 301b, 302b of each micro lens 30, 30a, 30b, a neighboring inclined side face 301, 302, 301a, 302a, 301b, 302b of an adjacent micro lens 30, 30a, 30b and the light incident face 20, 20a, 20b located therebetween cooperatively define a substantially U-shaped groove 31, 31a, 31b, with a width of the groove 31, 31a, 31b increasing gradually from a bottom to an opening thereof

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A light guide plate comprising:
a light incident face;
a bottom face adjacent to the light incident face; and
a light exit face adjacent to the light incident face and opposite to the bottom face;
wherein a plurality of micro lenses are formed on the light incident face in series to diffuse light incident thereon, and every two adjacent micro lenses cooperatively define a V-shaped groove therebetween; and
wherein each groove defines an opening, and the width of the openings of the grooves gradually changes from a center of the light incident face toward lateral sides thereof

2. The light guide plate of claim 1, wherein the width of the openings of the grooves firstly decreases gradually and then increases gradually from the center of the light incident face toward the lateral sides thereof.

3. The light guide plate of claim 1, wherein the width of the openings of the grooves increases gradually from the center of the light incident face toward the lateral sides thereof

4. The light guide plate of claim 3, wherein the light incident face is perpendicular to the light exit face, and each micro lens extends longitudinally from the light exit face to the bottom face of the light guide plate.

5. The light guide plate of claim 4, wherein each micro lens is elongated, and a depth of each groove between every two adjacent micro lenses is equal to each other.

6. The light guide plate of claim 5, wherein each micro lens has a triangular or trapezoidal cross section.

7. The light guide plate of claim 6, wherein when each micro lens has a triangular cross section, each micro lens has an isosceles triangular cross section, and the apex angles of the micro lenses increase gradually from the center of the light incident face toward the lateral sides thereof

8. A backlight module comprising:
at least one LED light source; and
a light guide plate coupled to the at least one LED light source, and the guide plate comprising a light incident face, a bottom face adjacent to the light incident face and a light exit face adjacent to the light incident face and opposite to the bottom face;
wherein a plurality of micro lenses are formed on the light incident face in series to diffuse light incident thereon, and every two adjacent micro lenses cooperatively define a groove therebetween, each groove defining an opening, the width of the openings of the grooves gradually changing from a center of the light incident face toward lateral sides thereof; and
wherein the at least one LED light source faces the light incident face of the light guide plate.

9. The backlight module of claim 8, wherein the width of the openings of the grooves firstly decreases gradually and then increases gradually from the center of the light incident face toward the lateral sides thereof.

10. The backlight module of claim 9, wherein the at least one LED light source includes a pair of LED light sources which are symmetrically positioned in front of the light incident face of the light guide plate with respect to the center of the light incident face of the light guide plate, and an optical axis of each LED light source is aligned with one of the grooves having a minimum opening width.

11. The backlight module of claim 8, wherein the width of the openings of the grooves increases gradually from the center of the light incident face toward the lateral sides thereof, and the at least one LED light source includes an LED light source aligning with the center of the light incident face.

12. The backlight module of claim 11, wherein the light incident face is perpendicular to the light exit face, and each micro lens extends longitudinally from the light exit face to the bottom face of the light guide plate.

13. The backlight module of claim 12, wherein each micro lens is elongated, and a depth of each groove between two adjacent micro lenses is equal to each other.

14. The backlight module of claim 13, wherein each micro lens has a triangular or trapezoidal cross section.

15. The backlight module of claim 14, wherein when each micro lens has a triangular cross section, and each micro lens has an isosceles triangular cross section, the apex angles of the micro lenses increase gradually from the center of the light incident face toward the lateral sides thereof

16. The backlight module of claim 8, wherein each groove is V-shaped.

17. A light guide plate comprising:
a light incident face;
a bottom face adjacent to the light incident face; and
a light exit face adjacent to the light incident face and opposite to the bottom face;
wherein a plurality of micro lenses are formed on the light incident face in series to diffuse light incident thereon, each micro lens comprises two opposite inclined side surfaces, and an inclined side surface of the micro lens and a neighboring inclined side surface of an adjacent micro lens cooperatively define an angle therebetween; and
wherein the angles defined between two adjacent micro lenses of the plurality of micro lenses gradually change from a center of the light incident face toward the lateral sides thereof.

18. The light guide plate of claim 17, wherein the angles defined between two adjacent micro lenses of the plurality of micro lenses firstly decreases gradually and then increases gradually from the center of the light incident face toward the lateral sides thereof.

19. The light guide plate of claim 17, wherein the angles defined between two adjacent micro lenses of the plurality of micro lenses increases gradually from the center of the light incident face toward the lateral sides thereof.

20. The light guide plate of claim 19, wherein the light incident face is perpendicular to the light exit face, each micro lens extends longitudinally from the light exit face to the bottom face of the light guide plate, an inclined side surface of each micro lens and a neighboring inclined side surface of an adjacent micro lens intersecting with each other to define a V-shaped groove therebetween.
